(19) United States
(12) Patent Application Publication
(10) Pub. No.: US 2025/0368315 A1
(43) Pub. Date: Dec. 4, 2025

(54) ENGINE PYLON ASSEMBLY WITH A CONTROL SURFACE FOR AN AIRCRAFT

(71) Applicant: General Electric Company, Schenectady, NY (US)

(72) Inventors: Arthur William Sibbach, Boxford, MA (US); Jonathan Edward Coleman, Mason, OH (US); Brandon Wayne Miller, Middletown, OH (US)

(21) Appl. No.: 18/732,902

(22) Filed: Jun. 4, 2024

(51) Int. Cl. B64C 5/02; B64C 39/10; B64D 27/40

(52) U.S. Cl. CPC B64C 5/02; B64D 27/402; B64C 2039/105

(57) ABSTRACT

An aircraft includes an aircraft body and an engine supported relative to the aircraft body. In addition, the aircraft includes a pylon assembly extending between the aircraft body and the engine. The pylon assembly includes a pylon structure coupling the engine to the aircraft body, and a pylon control surface coupled to and movable relative to at least a portion of the pylon structure.

### FIELD

The present disclosure relates generally to control surfaces for aircraft and, more particularly, to the incorporation of a control surface into an engine pylon assembly for an aircraft.

### BACKGROUND

As is generally understood, aircraft typically include various different control surfaces, such as rudders, elevators, ailerons, flaps, slats, etc. Conventionally, these control surfaces have been placed at certain locations on the aircraft, such as on the wings or on the tail of the aircraft. However, as aircraft designs progress and change over time, the design of control surfaces must similarly be assessed to accommodate differing aircraft configurations while maintaining aerodynamic efficiency and suitable flight control. Accordingly, new control surface designs would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a perspective view of one embodiment of an aircraft in accordance with aspects of the present subject matter, particularly illustrating the aircraft configured as a blended wing body (BWB) aircraft;

FIG. 2 illustrates a schematic, cross-sectional view of one embodiment of a first engine of the aircraft shown in FIG. 1 in accordance with aspects of the present subject matter, particularly illustrating the engine supported relative to an aircraft body via a pylon structure;

FIG. 3 illustrates a schematic, front view of one embodiment of the aircraft shown in FIG. 1, particularly illustrating the aircraft including laterally spaced engines supported relative to the aircraft body via pylon assemblies configured in accordance with aspects of the present subject matter;

FIG. 4 illustrates a schematic, side view of a portion of the aircraft shown in FIG. 3, particularly illustrating the connection provided between the aircraft body and the first engine via one embodiment of a pylon assembly in accordance with aspects of the present subject matter;

FIG. 5 illustrates a schematic, cross-sectional view of the pylon assembly shown in FIG. 4 taken about line 5-5, particularly illustrating exemplary pivoting motion of the pylon control surface about its vertical pivot axis relative to the pylon structure in accordance with aspects of the present subject matter;

FIG. 6 illustrates a schematic, front view of another embodiment of the aircraft shown in FIG. 1, particularly illustrating the aircraft including vertically stacked engines, with the upper or top engine being supported relative to the aircraft body via a pylon assembly in accordance with aspects of the present subject matter;

FIG. 7 illustrates a schematic, side view of the aircraft shown in FIG. 6, particularly illustrating the pylon assembly being used to support the upper or top engine of the vertically stacked engines relative to the aircraft body in accordance with aspects of the present subject matter;

FIG. 8 illustrates another schematic, side view of the portion of the aircraft shown in FIG. 4 incorporating another embodiment of a pylon assembly in accordance with aspects of the present subject matter, particularly illustrating the connection provided between the aircraft body and the first engine via the pylon assembly in accordance with aspects of the present subject matter;

FIG. 9 illustrates a schematic, cross-sectional view of the pylon assembly shown in FIG. 8 taken about line 9-9, particularly illustrating exemplary pivoting motion of the pylon control surface about its vertical pivot axis relative to the pylon structure in accordance with aspects of the present subject matter;

FIG. 10 illustrates another schematic, cross-sectional view of the pylon assembly shown in FIG. 8, particularly illustrating exemplary pivoting motion of both the pylon control surface and the aft pylon casing about their respective vertical pivot axes in accordance with aspects of the present subject matter;

FIG. 11 illustrates a schematic, front view of another embodiment of the aircraft shown in FIG. 3, particularly illustrating the aircraft including both pylon assemblies for supporting the engines relative to the aircraft body and tail assemblies extending outwardly from the engines opposite the pylon assemblies in accordance with aspects of the present subject matter;

FIG. 12 illustrates a schematic, side view of a portion of the aircraft shown in FIG. 11, particularly illustrating the connection between the aircraft body and the first engine provided via one embodiment of a pylon assembly in accordance with aspects of the present subject matter and one embodiment of a tail assembly extending outwardly from the engine in accordance with aspects of the present subject matter;

FIG. 13 illustrates a schematic, front view of another embodiment of the aircraft shown in FIG. 3, particularly illustrating the aircraft including both pylon assemblies for supporting the engines relative to the aircraft body and an elevator assembly extending between the engines in the lateral direction in accordance with aspects of the present subject matter;

FIG. 14 illustrates a schematic, cross-sectional view of the elevator assembly shown in FIG. 13 taken about line 13-13, particularly illustrating exemplary pivoting motion of an elevator control surface of the elevator assembly in accordance with aspects of the present subject matter;

FIG. 15 illustrates a schematic, front view of alternative embodiment of the aircraft shown in FIG. 13, particularly illustrating the aircraft including both pylon assemblies for supporting the engines relative to the aircraft body and first and second elevator assemblies extending outwardly from the engines in accordance with aspects of the present subject matter;

FIG. 16 illustrates a schematic, front view of an alternative embodiment of the aircraft shown in FIG. 11, particularly illustrating the aircraft including both pylon assemblies for supporting the engines relative to the aircraft body and tail assemblies extending outwardly from the engines opposite the pylon assemblies, with the pairs of pylon and tail assembles being outwardly skewed or tilted in accordance with aspects of the present subject matter; and

FIG. 17 illustrates a schematic, front view of an alternative embodiment of the aircraft shown in FIG. 11, particularly illustrating the aircraft including both pylon assemblies for supporting the engines relative to the aircraft body and tail assemblies extending outwardly from the engines opposite the pylon assemblies, with the pairs of pylon and tail assembles being inwardly skewed or tilted in accordance with aspects of the present subject matter.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “forward” and “aft” refer to relative positions within a gas turbine engine or vehicle, and are based on a normal operational attitude of the gas turbine engine or vehicle. More particularly, forward and aft are used herein with reference to a direction of travel of the vehicle and a direction of propulsive thrust of the gas turbine engine.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

In general, the present subject matter is directed to an aircraft having a pylon assembly that incorporates or includes a control surface. Specifically, in several embodiments, the pylon assembly may be configured to connect or couple an engine of the aircraft to a portion of the aircraft body. In general, the pylon assembly may include a pylon structure that at least partially functions as the mechanical connecting structure between the engine and the aircraft body and a pylon control surface coupled to and movable relative to the pylon structure. For instance, in one embodiment, the pylon control surface may be configured as a rudder that is pivotable relative to the pylon structure about a vertical pivot axis. In this regard, the pylon assembly may generally be configured to function as a vertical stabilizer in addition to providing the mechanical connection between the engine and the aircraft body.

In several embodiments, the pylon assembly (including the pylon structure and the pylon control surface) may be positioned directly between (e.g., vertically between) the engine and the aircraft body. In one embodiment, the pylon control surface may be coupled to the pylon structure at a location rearward of the aft engine mount provided between the pylon structure and the engine. In another embodiment, the pylon control surface may be positioned between the forward and aft engine mounts of the aircraft. In such an embodiment, the pylon structure may be sub-divided or separated into forward and aft portions, with the pylon control surface being positioned between the forward and aft portions of the pylon structure.

In addition to the control surface provided in association with the pylon assembly, additional control surfaces may be incorporated into the aircraft. For instance, the aircraft may also include a tail assembly extending outwardly from the engine opposite the pylon assembly. In such an embodiment, the tail assembly may incorporate a tail control surface. As will be described below, the pylon and tail assemblies may be vertically oriented assemblies such that each respective control surface corresponds to a vertically oriented control surface that functions as a rudder for the aircraft. In another embodiment, the pylon and tail assemblies may be tilted inwardly or outwardly such that the assemblies are oriented at an inward or outward tilt angle relative to the vertical direction. Additionally, the aircraft may also include an elevator assembly having an elevator control surface such that the elevator assembly is configured to function as a horizontal stabilizer. In one embodiment, the elevator assembly may extend horizontally between the engines of the aircraft. In another embodiment, each engine may include an elevator assembly extending outwardly therefrom.

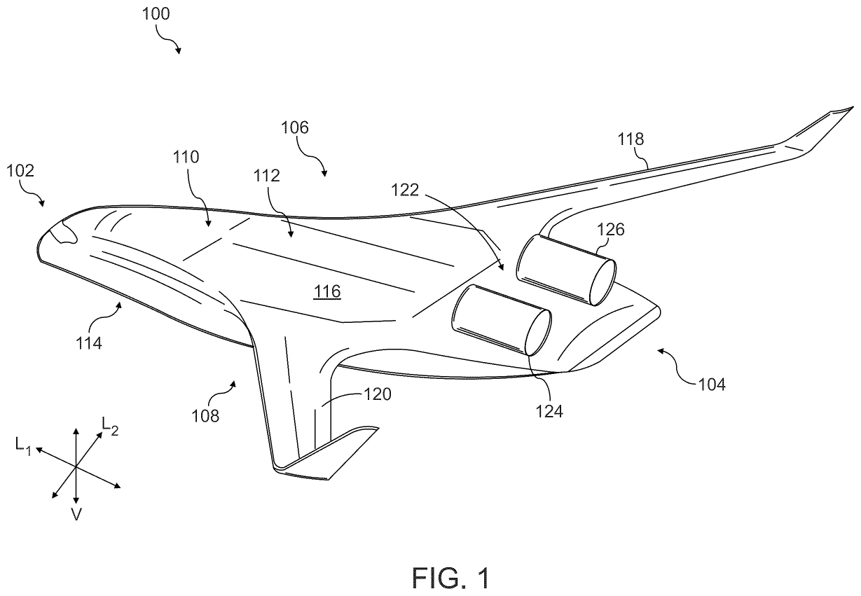

Referring now to the drawings, wherein identical numerals indicate the same elements throughout the figures, FIG. 1 illustrates a perspective view of an aircraft 100 as may incorporate various embodiments of the present disclosure. In particular, the aircraft 100 of FIG. 1 is configured as a blended wing body (BWB) aircraft.

The aircraft 100 defines a longitudinal direction L1 that extends therethrough, a lateral direction L2, a vertical direction V, a forward end 102 and an opposing aft end 104 along the longitudinal direction L1, a starboard side 106 and an opposing port side 108 along the lateral direction L2, and a top side 112 and an opposing bottom side 114 along the vertical direction V.

Further, it will be appreciated that the aircraft 100 includes an aircraft body 110 extending longitudinally from the forward end 102 of the aircraft 100 to the aft end 104 of the aircraft 100 and laterally from the starboard side 106 to the port side 108. As shown in FIG. 1, the aircraft body 110 includes a pair of wings. In particular, the aircraft body 110 includes a first wing 118 and a second wing 120. The first wing 118 extends outwardly from a central or fuselage portion of the body 110 generally along the lateral direction L2 on the starboard side 106 and the second wing 120 similarly extends outwardly from the central or fuselage portion of the body 110 generally along the lateral direction L2 on the port side 108. Although not depicted, it will be appreciated that each of the wings 118, 120 may include one or more leading edge flaps, one or more trailing edge flaps, or both.

The exemplary aircraft 100 of FIG. 1 also includes a propulsion system 122. The exemplary propulsion system 122 depicted includes a plurality of engines, and more specifically includes a first engine 124 and a second engine 126. In the embodiment depicted, the first engine 124 and the second engine 126 are spaced from one another along the lateral direction L2, and are mounted to the body 110 of the aircraft 100 at the aft end 104 of the aircraft 100. It will be appreciated, that as used herein, the term “at the aft end 104” refers to a location along the longitudinal direction L1 closer to the aft end 104 of the aircraft 100 than the forward end 102 of the aircraft 100. Briefly, it will further be appreciated that, for the embodiment depicted, the first engine 124 and second engine 126 are mounted to the body 110 of the aircraft 100 on the top side 112 of the aircraft 100. As will be described below, the aircraft 100 may, in other embodiments, have a vertically stacked engine configuration in which the first and second engines 124, 126 are aligned along a vertical plane extending in the longitudinal direction L1.

As noted above, the aircraft 100 is configured as a blended wing body aircraft and, thus, the aircraft body 110 generally corresponds to a blended wing body. In such a manner, it will be appreciated that the central or fuselage portion of the aircraft body 110 is generally shaped like an airfoil, so that such portion of the aircraft body 110 generates upward lift (along the vertical direction V) during steady altitude flight operations. For example, during a cruise operating condition of the aircraft 100, the central or fuselage portion of the body 110 may contribute between 25% and 95% of the upward lift for the aircraft 100, such as between 35% and 90% of the upward lift for the aircraft 100, with the remainder being provided by the first and second wings 118, 120 of the body 110. In addition, the first and second wings 118, 120 are aerodynamically contoured to have a smooth transition with the central or fuselage portion of the body 110 of the aircraft 100, which can reduce an overall drag on the aircraft 100.

It should be appreciated that, although the present subject matter will generally be described herein with reference to a blended wing body aircraft, the disclosed control surfaces may be utilized in association with any other suitable aircraft having any other suitable aircraft configuration, including an aircraft having a conventional fuselage and wing configuration.

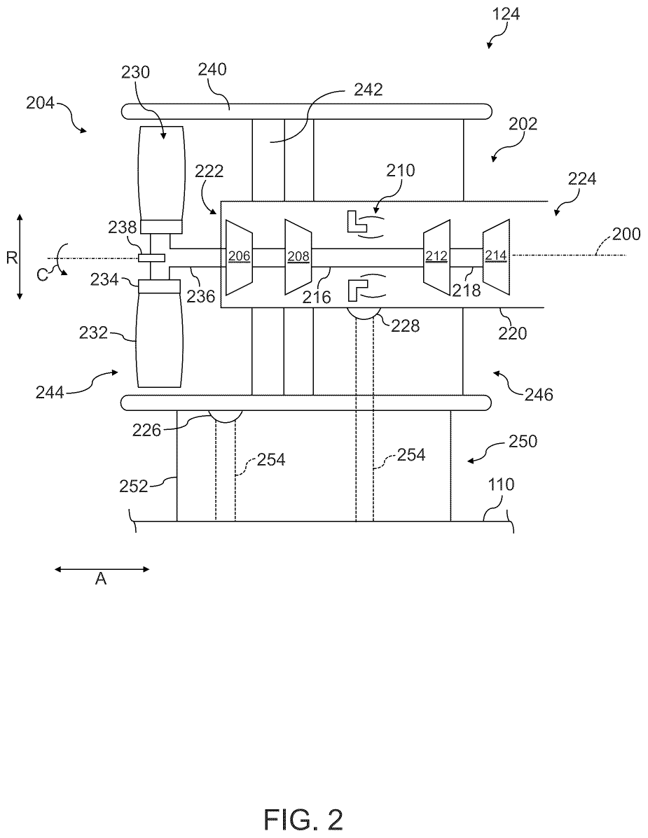

Referring now to FIG. 2, a schematic, cross-sectional view of one embodiment of an engine configured for use with an aircraft is illustrated in accordance with aspects of the present subject matter. For purposes of description, the engine shown in FIG. 2 will be described with reference to the first engine 124 of the aircraft 100 shown and described above with reference to FIG. 1. However, it should be appreciated that the illustrated engine configuration may also be applicable to the second engine 126 of the aircraft 100 shown and described above with reference to FIG. 1.

As shown in FIG. 2, the engine 124 generally extends axially (e.g., along axial direction A) along a centerline 200 of the engine. In general, the engine 124 includes a turbomachine 202 comprising a fan assembly 204, a low pressure compressor 206, a high pressure compressor 208, a combustion section 210, a high pressure turbine 212, and a low pressure turbine 214. The turbomachine 202 is supported within a turbomachine casing 220 extending axially between a turbomachine inlet 222 and a turbomachine exhaust 224. As shown in FIG. 2, the combustion section 210 is positioned axially between the high pressure compressor 208 and the high pressure turbine 212, with the high pressure compressor 208 being connected to the high pressure turbine 212 via a high pressure shaft 216. Similarly, the low pressure turbine 214 (and the low pressure compressor 206) is connected to the fan assembly 204 via a low pressure shaft 218, allowing for the coordinated operation of such components. The various shafts of the engine 124 are generally rotatable about the engine centerline 200 in a circumferential direction C of the engine.

As shown in FIG. 2, the fan assembly 204 includes a fan 230 having fan blades 232 coupled to and extending radially outwardly (e.g., in radial direction R) from a fan disk 234, which is in turn coupled to a fan shaft 236 of the fan assembly 204. The fan shaft 236 extends axially and is operatively connected to a pitch change mechanism 238. The pitch change mechanism 238 can adjust the pitch of the fan blades 232 to control the thrust produced by the fan assembly 204. Additionally, as shown in FIG. 2, the fan assembly 204 is enclosed by an outer nacelle 240 extending axially between an inlet 244 of the fan assembly 204 and a fan exhaust 246 at an opposing end of the assembly 204. Outlet guide vanes 242 are provided within the nacelle 240 downstream of the fan 230 to guide the airflow flowing from the fan 230.

As shown in FIG. 2, the engine 124 is generally configured to be supported relative to a body of the aircraft (e.g., aircraft body 110) via a pylon structure 250. In particular, the pylon structure 250 extends between and couples the engine 124 to the aircraft body 110. As shown in FIG. 2, the pylon structure 250 includes an outer pylon casing 252 and one or more internal mounting elements 254 (shown schematically in FIG. 2) for mounting or supporting the engine 124 relative to the aircraft body 110. As is generally understood, the outer pylon casing 252 may be configured to have an aerodynamic shape to minimize the effect of the structure on the aerodynamic performance of the aircraft 100. Additionally, in one embodiment, the internal mounting elements 254 of the pylon structure 250 may be used to couple to the aircraft body 110 to the engine via forward and aft engine mounts 226, 228. For instance, as shown in FIG. 2, the forward engine mount 226 is provided in association with the outer nacelle 240 while the aft engine mount 228 is provided in association with the turbomachine casing 220. In such an embodiment, the internal mounting elements 254 may be coupled between the aircraft body 110 and the forward and aft engine mounts 226, 228 to provide secure attachment points between the engine 124 and the body 110.

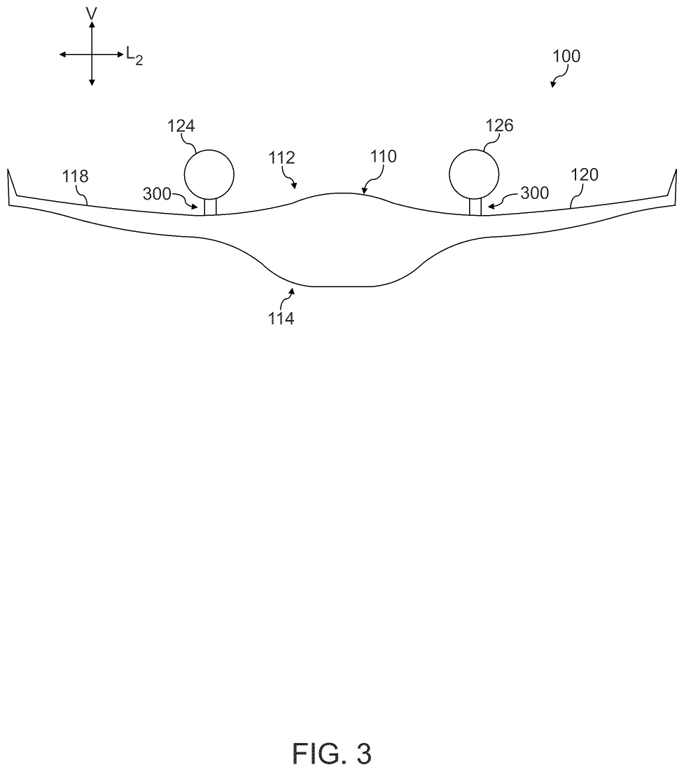

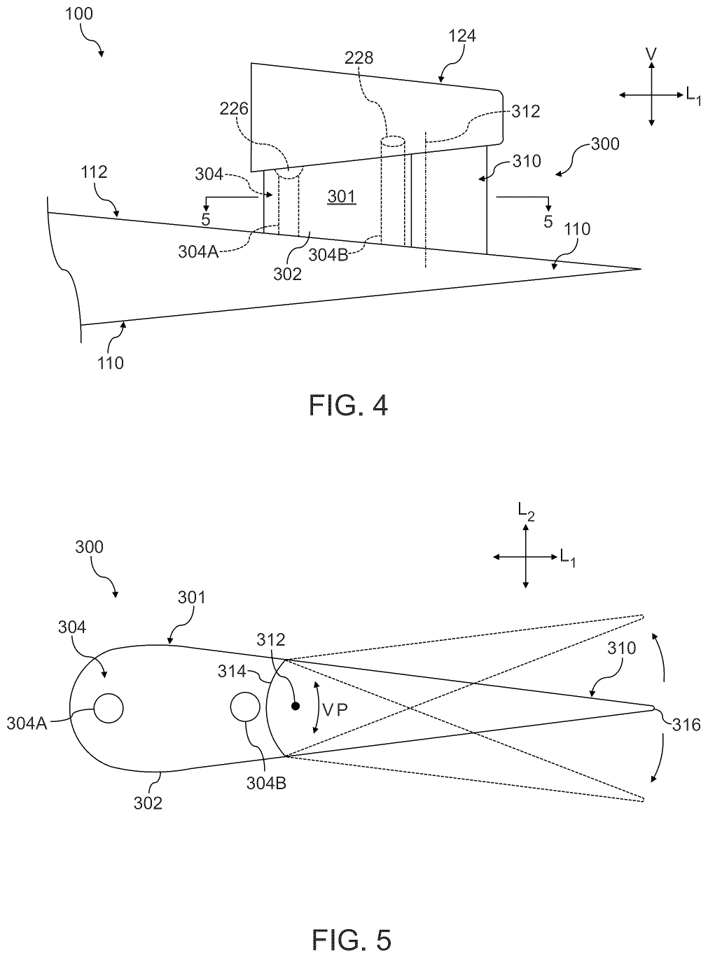

Referring now to FIGS. 3-5, different schematic views of the aircraft 100 shown in FIG. 1 are illustrated, particularly illustrating the laterally spaced engines 124, 126 of the aircraft 100 being supported relative to the aircraft body 110 via respective pylon assemblies 300 configured in accordance with aspects of the present subject matter. Specifically, FIG. 3 illustrates a schematic, front view of the aircraft 100, with each engine 124, 126 being coupled to the aircraft body 110 via a pylon assembly 300 extending vertically therebetween. FIG. 4 illustrates a schematic, side view of the aircraft 100, particularly illustrating the connection provided between the aircraft body 110 and the first engine 124 of the aircraft 100 via the respective pylon assembly 300. Additionally, FIG. 5 illustrates a schematic, cross-sectional view of the pylon assembly 300 shown in FIG. 4 taken about line 5-5. It should be appreciated that, although FIGS. 4 and 5 only illustrate the pylon assembly 300 provided in association with the first engine 124, the connection provided between the aircraft body 110 and the second engine 126 via the respective pylon assembly 300 (as well as the configuration of such respective pylon assembly 300) may be configured the same as that shown in FIGS. 4 and 5.

In general, the disclosed pylon assemblies 300 may be configured as dual-function assemblies of the aircraft. In particular, the pylon assemblies 300 may function to not only support the engines 124, 126 relative to the aircraft body 110, but also to provide improved aircraft performance. In particular, as will be described below, each pylon assembly 300 may incorporate or integrate a control surface disposed between the aircraft body 110 and its respective engine 124, 126 to provide additional stability and/or control capabilities to the aircraft 100, which improves aircraft performance. In addition, the pylon assemblies 300 may also facilitate the routing of necessary utilities, such as fuel lines, electrical wiring, and hydraulic systems, between the engines 124, 126 and the aircraft body 110.

As particularly shown in FIGS. 4 and 5, each pylon assembly 300 includes a pylon structure 301 and a pylon control surface 310 coupled to and movable relative to at least a portion of the pylon structure 301. The pylon structure 301 comprises an outer pylon casing 302 and one or more internal pylon mounting elements 304 positioned and extending within the pylon casing 302 for coupling the engine 124 to the aircraft body 110. For instance, as particularly shown in FIG. 4, the pylon structure 301 includes one or more forward pylon mounting elements 304A and one or more aft pylon mounting elements 304B encased or positioned within the pylon casing 302, with the forward pylon mounting element(s) 304A being configured to be coupled between the aircraft body 110 and the forward engine mount 226 and the aft pylon mounting element(s) 304B being configured to be coupled between the aircraft body 110 and the aft engine mount 228. It should be appreciated that the pylon structure 301 may generally incorporate any number of internal pylon mounting elements 304 for securing the engine 124 to the aircraft body 110 and that such mounting elements 304 may be interconnected as desired. For instance, although not shown, various intermediate or connecting elements may be coupled between the forward and aft mounting elements 304A, 304B.

As shown in FIGS. 4 and 5, the pylon control surface 310 is generally configured to be coupled to an aft portion of the pylon structure 301 and extend rearwardly therefrom in the longitudinal direction L1, while also extending vertically between the engine 124 and the aircraft body 110. For instance, as particularly shown in FIG. 5, the pylon control surface 310 may generally extend in the longitudinal direction L1 between a forward end 314 of the pylon control surface 310 and an aft end 316 of the pylon control surface 310, with the forward end 314 being coupled to and positioned adjacent to the aft portion of the pylon structure 301 at a location rearward of the aft internal mounting element 304B and the control surface 310 extending rearwardly therefrom to its distal, aft end 316. In this regard, as particularly shown in FIG. 4, the positioning of the pylon control surface 310 may be such that the control surface 310 is positioned aft or rearward of the aft engine mount 228 in addition to generally being positioned aft or rearward of the pylon structure 301.

As particularly shown in FIG. 5, the pylon control surface 310 may be pivotable relative to the pylon structure 301 about a vertical pivot axis 312 (e.g., pivotable in the vertical pivot direction VP shown in FIG. 5). The pivotal movement of the pylon control surface 310 about the vertical pivot axis 312 generally enables the aircraft 100 to achieve directional stability and control. For instance, in the illustrated embodiment, the pylon assembly 300 may generally function as a vertical stabilizer, with the pylon control surface 310 acting as a vertically oriented rudder for the aircraft 100. In this regard, the pylon control surface 310 offers a compact and efficient solution for integrating a rudder into the aircraft design, reducing the need for a separate vertical stabilizer and potentially lowering the overall weight and drag of the aircraft. However, as will be described below, the pylon control surface 310 may be used in combination with other control surfaces as desired, such as additional rudders, elevators, and/or any other suitable control surfaces positioned at various different locations about the aircraft 100.

It should be appreciated that the pylon control surface 310 may be configured to be actuated using various mechanisms, such as hydraulic, electric, or pneumatic actuators, which can be controlled by the aircraft's flight control system. In addition, the pylon control surface 310 may also include features, such as trim tabs or balance panels, to fine-tune its aerodynamic properties and to enhance the precision of control inputs. It should also be appreciated that the disclosed control surfaces may generally be formed from any suitable material that allows such surfaces to function as described herein.

Additionally, it should be appreciated that the present disclosure generally contemplates various embodiments of pylon control surfaces, wherein such surfaces can be designed with different sizes, shapes, and configurations to optimize or enhance the aerodynamic performance and control authority for specific aircraft designs and operational requirements. The disclosed pylon control surfaces may also be designed to deflect in opposite directions when used in a multi-engine configuration, providing additional capabilities such as differential thrust vectoring or acting as a braking surface during landing.

Moreover, it should be appreciated that the disclosed pylon assembly 300 can be adapted to various engine configurations and mounting arrangements. Similarly, the disclosed pylon assembly can be utilized in both single-engine and multi-engine aircraft, providing a consistent and reliable means of attaching engines to an aircraft body, while also contributing to the overall control and stability of the aircraft.

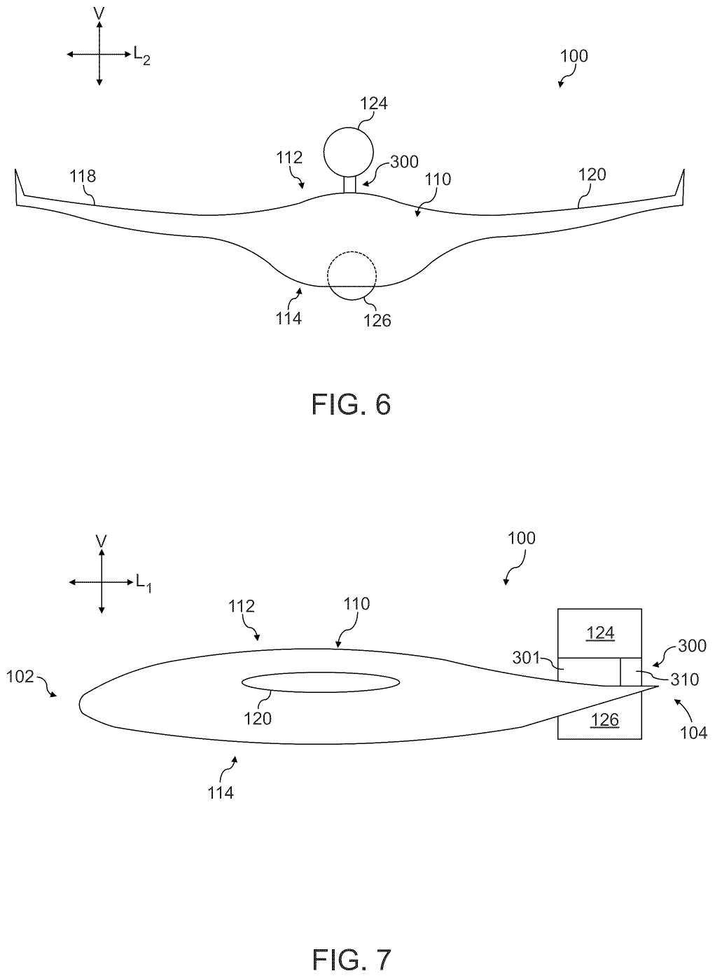

Referring now to FIGS. 6 and 7, schematic views of an alternative engine configuration for the aircraft 100 described above is illustrated in accordance with aspects of the present subject matter, particularly illustrating a vertically stacked configuration for the engines 124, 126 of the aircraft 100. Specifically, FIG. 6 illustrates a schematic, front view of the aircraft 100, while FIG. 7 illustrates a schematic, side view of the aircraft 100.

As shown in FIGS. 6 and 7, unlike the laterally spaced engine configuration described above, the aircraft 100 includes stacked or aligned engines 124, 126 in the vertical direction V, with the first engine 124 being supported relative to the aircraft body 110 along the top side 112 thereof and the second engine 126 being supported relative to the aircraft body 110 along the bottom side 113 thereof. For instance, in one embodiment, the engines 124, 126 may be vertically aligned with each other along a vertical plane extending in the longitudinal direction L1 of the aircraft 100, such as a vertical plane extending along the longitudinal centerline of the aircraft 100.

Similar to the embodiment described above, a pylon assembly 300 may be used to mount one or both of the engines 124, 126 to the aircraft body 110, with the pylon assembly 300 being configured in the same or a similar manner as that described herein (e.g., by configuring the pylon assembly 300 to include a pylon structure 301 and a pylon control surface 310 coupled to and movable relative to the pylon structure 301). For instance, the pylon assembly 300 may generally be configured as a vertical stabilizer for the aircraft 100, with its respective pylon control surface functioning as a vertically oriented rudder.

In the illustrated embodiment, the first engine 124 is shown as being coupled to the aircraft body 110 via a pylon assembly 300, while the second engine 126 is shown as being coupled to the aircraft body 110 without the use of a respective pylon assembly 300. In such an embodiment, the second engine 126 may, for example, be coupled to the aircraft body 110 via a conventional pylon structure or assembly (e.g., in the manner described above with reference to the pylon structure 250 of FIG. 2) or in any other suitable manner. In an alternative embodiment, both the first engine 124 and the second engine 126 may be coupled to the aircraft body 110 via a respective pylon assembly 300. In another embodiment, the second engine 126 may be coupled to the aircraft body 110 via a pylon assembly 300, while the first engine 124 may be coupled to the aircraft body 110 without the use of a respective pylon assembly 300 (e.g., by using a conventional pylon structure, such as the structure 250 of FIG. 2).

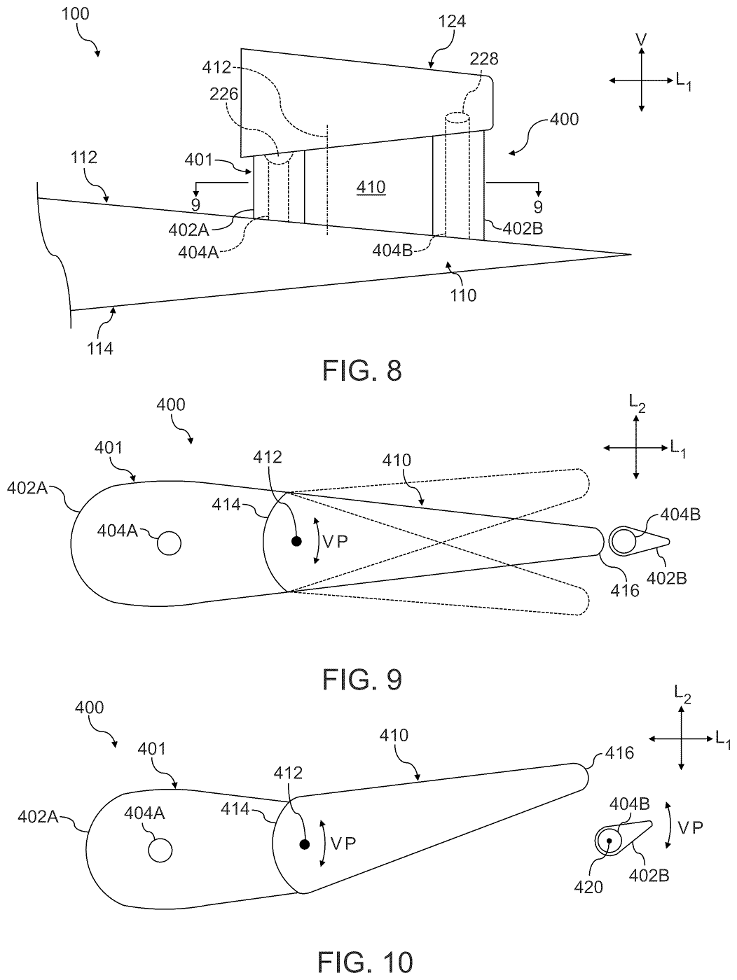

Referring now to FIGS. 8-10, various schematic views of an alternative embodiment of a pylon assembly 400 configured for use with an aircraft (e.g., aircraft 100) are illustrated in accordance with aspects of the present subject matter. Specifically, FIG. 8 illustrates a schematic side view of a portion of an aircraft 100, particularly illustrating the connection provided between an aircraft body 110 and an engine of the aircraft 100 (e.g., first engine 124) via the respective pylon assembly 400. FIG. 9 illustrates a schematic, cross-sectional view of the pylon assembly shown in FIG. 8 taken about line 9-9, particularly illustrating exemplary pivoting motion of a control surface of the pylon assembly 400. Additionally, FIG. 10 illustrates a similar cross-sectional view of the pylon assembly as that shown in FIG. 9, particularly illustrating the ability for simultaneous pivoting of both the control surface of the pylon assembly 400 and a portion of the casing of a pylon structure of the pylon assembly 400. It should be appreciated that, for purposes of description, the pylon assembly 400 will generally be described with reference to the configuration of the aircraft 100 shown in FIG. 1. However, in other embodiments, the disclosed pylon assembly 400 may be advantageously utilized with aircraft having any other suitable aircraft configuration. In this regard, it should be appreciated that the disclosed pylon assembly 400 may be utilized within an aircraft having any suitable engine arrangement, such as the laterally spaced engine arrangement shown in FIGS. 1 and 3 or the vertically stacked engine arrangement shown in FIGS. 6 and 7.

As shown in FIGS. 8-10, similar to the embodiment of the pylon assembly 300 described above, the pylon assembly 400 generally includes a pylon structure 401 and a pylon control surface 410 coupled to and movable relative to at least a portion of the pylon structure 401. However, unlike the embodiment of the pylon assembly 400 described above, the pylon structure 401 is sub-divided or separated into separate forward and aft portions, with such portions of the pylon structure 401 generally functioning as the mechanical connection or support for the engine 124 relative to the aircraft body 110. Specifically, as shown in FIGS. 8-10, the pylon structure includes both a forward pylon casing 402A and an aft pylon casing 402B, with the aft pylon casing 402B being separated and spaced apart rearwardly from the forward pylon casing 402A in the longitudinal direction L1 of the aircraft 100. The forward and aft pylon casings 402A, 402B may generally be configured to house or encase one or more internal structural elements for coupling the engine 124 to the aircraft body 110. For instance, as shown in the illustrated embodiment, the forward pylon casing 402A may be configured to house one or more forward pylon mounting elements 404A for coupling the engine 124 to the aircraft body 110 via the forward engine mount 226. Similarly, the aft pylon casing 402B may be configured to encase one or more aft pylon mounting elements 404B that facilitate coupling the engine 124 to the aircraft body 110 via the aft engine mount 228.

As shown in the illustrated embodiment of FIGS. 8-10, with such a separated or sub-divided pylon structure 401, the pylon control surface 410 of the pylon assembly 400 may, in one embodiment, be positioned between the forward and aft pylon casings 402A, 402B such that the control surface 410 extends vertically between the aircraft body 110 and the engine 124 at a more centralized location of the pylon assembly 400. For instance, as particularly shown in FIGS. 8 and 9, the pylon control surface 410 may generally extend in the longitudinal direction L1 between a forward end 414 of the pylon control surface 310 and an aft end 416 of the pylon control surface 410, with the forward end 414 being coupled to and positioned adjacent to the aft portion of the forward pylon casing 4042A at a location rearward of the forward internal mounting element 404A and the control surface 310 extending rearwardly therefrom to its distal, aft end 416 positioned adjacent to a forward portion of the aft pylon casing 402B at a location forward of the aft internal mounting element 404B. In this regard, the positioning of the pylon control surface 410 may be such that the control surface 410 is positioned between the forward and aft engine mounts 226, 228 in the longitudinal direction L1 in addition to generally being positioned between the forward and aft portions of the pylon structure 401.

Additionally, as shown in FIGS. 9 and 10, the pylon control surface 410 may be pivotable relative to at least a portion of the pylon structure 401 about a vertical pivot axis 412 (e.g., pivotable in the vertical pivot direction VP shown in FIGS. 9 and 10). The pivotal movement of the pylon control surface 410 about the vertical pivot axis 412 generally enables the aircraft 100 to achieve directional stability and control. For instance, in the illustrated embodiment of FIGS. 8-10, the pylon assembly 400 may generally function as a vertical stabilizer, with the pylon control surface 410 acting as a vertically oriented rudder for the aircraft 100.

In one embodiment, the pylon control surface 410 may be pivotable relative both of the forward and aft pylon casings 402A, 402B about its vertical pivot axis 412, allowing the control surface 410 to be oriented at various different positions relative to such pylon casings 402A, 402B. Alternatively, as particularly shown in FIG. 10, the aft pylon casing 402B may be configured to pivot in association or together with the pivoting motion of the pylon control surface 410. For instance, as shown in FIG. 10, the aft pylon casing 402B may be pivotable about a vertical pivot axis 420 (e.g., along a vertical pivot direction VP) to allow the aft pylon casing 402B to be reoriented as desired to improve the overall aerodynamic efficiency of the pylon assembly 400 and/or to enhance the directional stability/control being provided by the control surface 410. In one embodiment, this coordinated movement may be used to enhance the aerodynamic performance of the pylon assembly 400 by aligning the aft pylon casing 402B with the pylon control surface 410 to reduce drag and/or improve airflow around and/or through the assembly 400. As an example, in one embodiment, the pylon control surface 410 and the aft pylon casing 402B may be configured to be pivoted simultaneously about their respective pivot axes 412, 420. In such an embodiment, the pylon control surface 410 may be pivoted to the same or a different pivot angle as the aft pylon casing 402B. Alternatively, the pylon control surface 410 and the aft pylon casing 402B may be configured to be pivoted independently (to the same or differing extents) as desired. It should be appreciated that the pylon control surface 410 and the aft pylon casing 402B may be configured to be actuated using various mechanisms, such as hydraulic, electric, or pneumatic actuators, which can be controlled by the aircraft's flight control system.

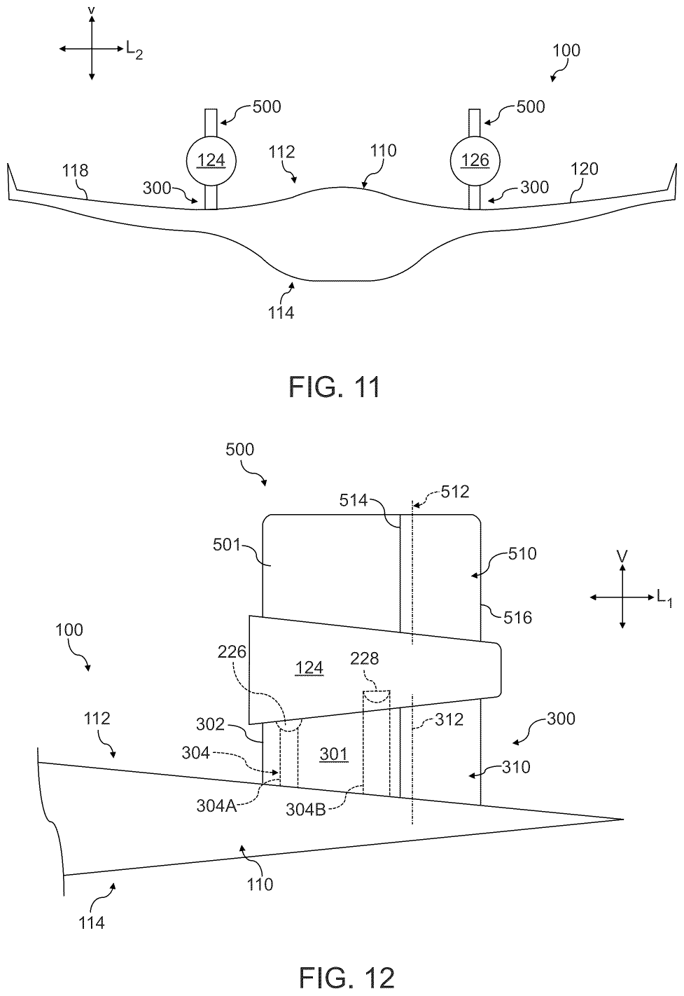

Referring now to FIGS. 11 and 12, schematic views of an alternative embodiment of the aircraft 100 shown in FIG. 1 are illustrated, particularly illustrating the laterally spaced engines 124, 126 of the aircraft 100 being provided in operative association with respective pylon assemblies 300 and tail assemblies 500 configured in accordance with aspects of the present subject matter. Specifically, FIG. 11 illustrates a schematic, front view of the aircraft 100, with each engine 124, 126 being coupled to the aircraft body 110 via a pylon assembly 300 extending vertically therebetween and further including a respective tail assembly 500 extending outwardly from each engine 124, 126. Additionally, FIG. 12 illustrates a schematic, side view of the aircraft 100, particularly illustrating the connection provided between the aircraft body 110 and the first engine 124 of the aircraft 100 via the respective pylon assembly 300 and further illustrating the configuration of the tail assembly 500. It should be appreciated that, although FIG. 12 only illustrates the pylon and tail assemblies 300, 500 provided in association with the first engine 124, the configuration of such assemblies 300, 500 that are provided in association with the second engine 126 may be the same as or similar to that shown in FIG. 12.

As shown in FIGS. 11 and 12, similar to the embodiments described above, each engine 124, 126 may be provided in operative association with a pylon assembly 300 configured to support its respective engine 124, 126 relative to the aircraft body 110 while also incorporating a control surface to provide for directional control/stability for the aircraft. In this regard, each pylon assembly 300 may generally have the same or similar configuration as any of the pylon assemblies described herein. For instance, as particularly shown in FIG. 12, in one embodiment, each pylon assembly 300 may be configured the same as or similar to the pylon assembly shown and described above with reference to FIGS. 4 and 5, in which case the pylon control surface may be coupled to the pylon structure at or adjacent to its aft end. Alternatively, each pylon assembly may be configured the same as or similar to the pylon assembly 400 shown and described above with reference to FIGS. 8-10, in which case the pylon control surface may be positioned between forward and aft portions of the associated pylon structure.

Additionally, as shown in FIGS. 11 and 12, each engine 124, 126 may be provided in operative association with a tail assembly 500 extending outwardly from the respective engine 124, 126 in a direction opposite the pylon assembly 300. Specifically, in the illustrated embodiment, each tail assembly 500 is generally vertically aligned with the respective pylon assembly 300 of its associated engine 124, 126 such that the pylon assembly 300 extends vertically between the aircraft body 110 and the bottom of the adjacent engine 124, 126 and the tail assembly 500 extends vertically upwardly from the top of such engine 124, 126.

As particularly shown in FIG. 12, each tail assembly 500 may include a tail structure 501 and a tail control surface 510, with the tail control surface 510 being coupled to and movable relative to at least a portion of the tail structure 501. For example, as shown in FIG. 12, the tail control surface 510 may extend in the longitudinal direction L1 between a forward end 514 and an aft end 516, with the forward end 514 being coupled and positioned adjacent to an aft portion of the tail structure 501 and the control surface 510 extending outwardly therefrom to its distal, aft end 516. In one embodiment, similar to the relative positioning of the pylon control surface 310, the tail control surface 510 may be positioned in the longitudinal direction L1 at a location rearward of the aft engine mount 228.

It should be appreciated that, in one embodiment, the tail structure 501 may be coupled to and/or supported by the adjacent engine 124, 126 in any suitable manner that allows each tail assembly to function as described herein.

Additionally, as particularly shown in FIG. 12, the tail control surface 510 may be pivotable relative to the tail structure 501 about a vertical pivot axis 512. The pivotal movement of the tail control surface 510 about the vertical pivot axis 512 generally enables the aircraft 100 to achieve directional stability and control. For instance, in the illustrated embodiment, the tail assembly 500 may generally function as a further vertical stabilizer in addition to the pylon assembly 300, with the tail control surface 510 acting as a vertically oriented rudder for the aircraft 100. As shown in FIG. 12, in one embodiment, the vertical pivot axes 312, 512 for each pylon/tail assembly pair may be vertically aligned, such as by being coaxially aligned along a common axis. Alternatively, the vertical pivot axes 312, 512 for each pylon/tail assembly pair may be offset in one or more directions. It should be appreciated that, similar to the pylon control surfaces 310, the tail control surfaces 510 may be actuated using various systems, such as hydraulic, electric, or pneumatic actuators, which can be controlled by the aircraft's flight control system based on pilot input or automated control algorithms.

It should also be appreciated that the aircraft 100, as depicted in FIGS. 11 and 12, may benefit from the dual vertical stabilizer configuration provided by each pylon/tail assembly pair. For instance, this arrangement can provide redundancy in control surfaces, enhancing the safety and maneuverability of the aircraft 100. Additionally, the tail control surfaces 510 can be controlled to work in concert with the pylon control surfaces 310, allowing for precise adjustments to the aircraft's direction and attitude during various phases of flight, including takeoff, cruising, and landing. Additionally, it should be appreciated that, although shown in association with the laterally spaced engine arrangement, the disclosed pylon/tail assembly pair may also be utilized in association with a vertically stacked engine arrangement, such as by including the tail assembly 500 in association with the engine 124 shown in FIGS. 6 and 7.

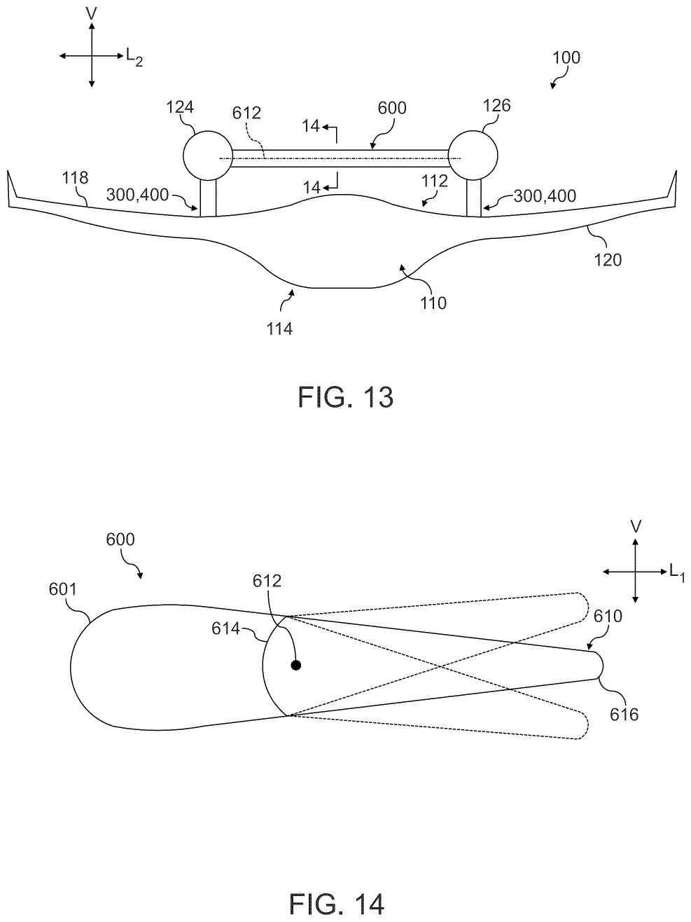

Referring now to FIGS. 13 and 14, schematic views of yet another alternative embodiment of the aircraft 100 shown in FIG. 1 are illustrated, particularly illustrating the laterally spaced engines 124, 126 of the aircraft 100 being provided in operative association with respective pylon assemblies 300 and an elevator assembly 600 extending between the engines 124, 126 in accordance with aspects of the present subject matter. Specifically, FIG. 13 illustrates a schematic, front view of the aircraft 100, with each engine 124, 126 being coupled to the aircraft body 110 via a pylon assembly 300 extending vertically therebetween and further including an elevator assembly 600 extending horizontally between the engines 124, 126 in the lateral direction L2. Additionally, FIG. 14 illustrates a schematic, cross-sectional view of the elevator assembly 600 shown in FIG. 13 taken about line 14-14, particularly illustrating exemplary pivoting motion of a control surface of the elevator assembly 600.

As shown in FIG. 13, similar to the embodiments described above, each engine 124, 126 may be provided in operative association with a pylon assembly 300, 400 configured to support its respective engine 124, 126 relative to the aircraft body 110 while also incorporating a control surface to provide for directional control/stability for the aircraft. In this regard, each pylon assembly 300, 400 may generally have the same or similar configuration as any of the pylon assemblies described herein, such as the pylon assembly 300 described above with reference to FIGS. 4 and 5 or the pylon assembly 400 described above with reference to FIGS. 8-10.

Additionally, as shown in FIG. 13, the aircraft 100 may include an elevator assembly 600 extending laterally between the engines 124, 126. As particularly shown in FIG. 14, the elevator assembly 600 may generally include an elevator structure 601 and an elevator control surface 610, with the elevator control surface 610 being coupled to and pivotable relative to the elevator structure 601 about a horizontal pivot axis 612. For instance, in the illustrated embodiment, the elevator control surface 610 extends from a forward end 614 of the elevator control surface 610 positioned adjacent and coupled to an aft portion of the elevator structure 601 to a distal, aft end 616 of the elevator control surface 610 spaced apart from the elevator structure 601. This configuration allows the elevator assembly 600 to generally function as a horizontal stabilizer, with the elevator control surface 610 acting as an elevator for the aircraft 100. It should be appreciated that, similar to the pylon control surfaces 310, the elevator control surface 610 may be actuated using various systems, such as hydraulic, electric, or pneumatic actuators, which can be controlled by the aircraft's flight control system based on pilot input or automated control algorithms. Additionally, it should be appreciated that, in one embodiment, the elevator structure 601 may be coupled to and/or supported between the engines 124, 126 in any suitable manner that allows the elevator assembly to function as described herein.

It should also be appreciated that the aircraft 100, as depicted in FIG. 13, may benefit from the integration of the elevator assembly 600, which provides additional control over the pitch of the aircraft. The positioning of the elevator assembly 600 between the engines 124, 126 along the lateral direction L2 allows for a balanced distribution of aerodynamic forces during flight, particularly between the vertically oriented control surfaces of the pylon assemblies 300, 400 and the horizontally oriented control surface of the elevator assembly.

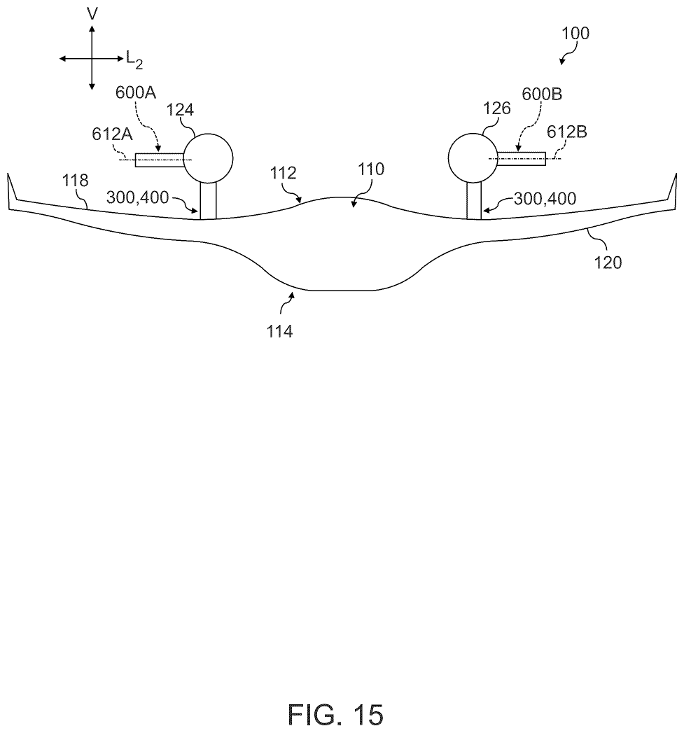

Referring now to FIG. 15, a schematic, front view of an alternative embodiment of the aircraft 100 shown in FIG. 13 is illustrated in accordance with aspects of the present subject matter. As shown in FIG. 15, as opposed to a single elevator assembly 600 extending horizontally between the engines 124, 126, the aircraft 100 may, instead, include separate elevator assemblies provided in operative association with the engines 124, 126. For instance, in the illustrated embodiment, the aircraft includes a first elevator assembly 600A extending outward form the first engine 124 and a second elevator assembly 600B extending outward from the second engine 126. Specifically, as shown in FIG. 15, the elevator assemblies 600A, 600B extend outwardly from their respective engines 124, 126 in opposed lateral directions L2 (i.e., in a direction away from the longitudinal centerline of the aircraft 100). However, in other embodiments, each elevator assembly 600A, 600B may extend inwardly from its respective engine 124, 126 in the lateral direction L2 (i.e., in a direction towards from the longitudinal centerline of the aircraft 100.

It should be appreciated that each elevator assembly 600A, 600B may generally be configured the same as or similar to the elevator assembly 600 described above with reference to FIG. 14. For instance, each elevator assembly 600A, 600B may generally include an elevator structure and an elevator control surface, with the elevator control surface being coupled to and pivotable relative to the elevator structure about a respective horizontal pivot axis 612A, 612B. As such, each elevator assembly 600A, 600B may function as a horizontal stabilizer, with its respective elevator control surface acting as an elevator for the aircraft 100.

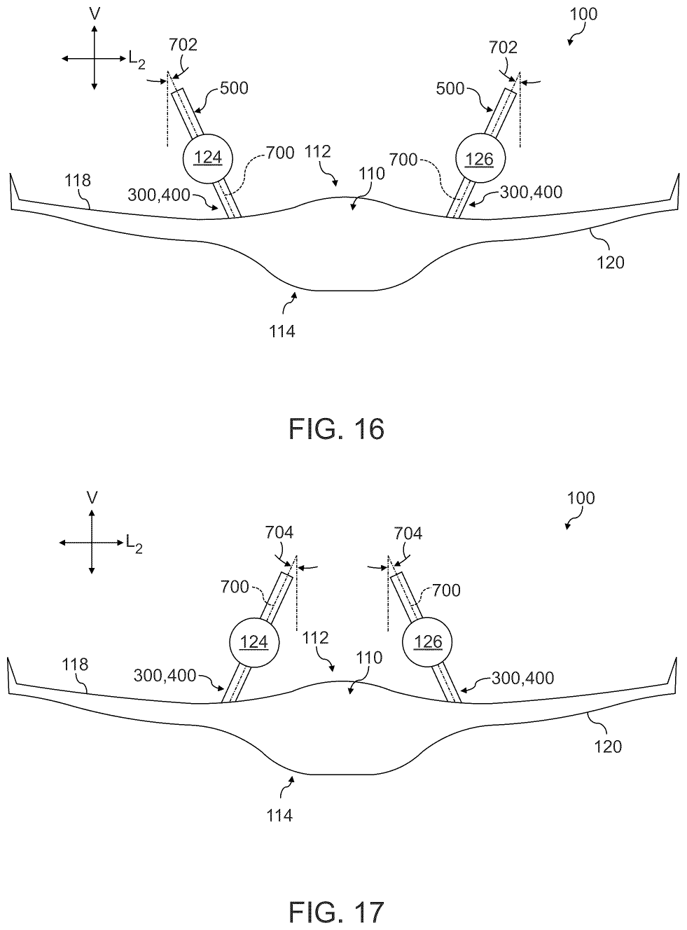

Referring now to FIG. 16, an alternative embodiment of the aircraft 100 shown in FIG. 11 is illustrated in accordance with aspects of the present subject matter. As shown in FIG. 16, as opposed to the vertically oriented elevator/tail assemblies depicted in the embodiment of FIG. 11, the pylon assemblies 300, 400 and tail assemblies 500 are tilted or skewed outwardly in the lateral direction L2. Specifically, as shown in FIG. 16, each engine 124, 126 is supported relative to the aircraft body 110 via a respective pylon assembly 300, 400 that is titled outwardly in the lateral direction L2 so as to be oriented along a tilt axis 700 that defines a non-zero outward tilt angle 702 relative to the vertical direction V. Similarly, each tail assembly 500 extends outwardly from its respective engine 124, 126 along the same the outward tilt axis 700 as its associated pylon assembly 300, 400 and thus, is also oriented at the outward tilt angle 702 relative to the vertical direction V. In this regard, it should be appreciated that the outward tilt angle 702 may generally correspond to any suitable angle ranging from greater than zero degrees to less than 90 degrees, such as an angle relative to vertical ranging from 5 degrees to 85 degrees or from 15 degrees to 75 degrees or from 25 degrees to 65 degrees and any other subranges therebetween.

Referring now to FIG. 17, another alternative embodiment of the aircraft 100 shown in FIG. 11 is illustrated in accordance with aspects of the present subject matter. As shown in FIG. 17, as opposed to the vertically oriented elevator/tail assemblies depicted in the embodiment of FIG. 11, the pylon assemblies 300, 400 and tail assemblies 500 are tilted or skewed inwardly in the lateral direction L2. Specifically, as shown in FIG. 17, each engine 124, 126 is supported relative to the aircraft body 110 via a respective pylon assembly 300, 400 that is titled inwardly in the lateral direction L2 so as to be oriented along a tilt axis 700 that defines a non-zero inward tilt angle 704 relative to the vertical direction V. Similarly, each tail assembly 500 extends outwardly from its respective engine 124, 126 along the same the inward tilt axis 700 as its associated pylon assembly 300, 400 and thus, is also oriented at the inward tilt angle 704 relative to the vertical direction V. In this regard, it should be appreciated that the inward tilt angle 704 may generally correspond to any suitable angle ranging from greater than zero degrees to less than 90 degrees, such as an angle relative to vertical ranging from 5 degrees to 85 degrees or from 15 degrees to 75 degrees or from 25 degrees to 65 degrees and any other subranges therebetween.

Further aspects are provided by the subject matter of the following clauses:

An aircraft comprising: an aircraft body; an engine supported relative to the aircraft body; and a pylon assembly extending between the aircraft body and the engine, the pylon assembly comprising: a pylon structure coupling the engine to the aircraft body; and a pylon control surface coupled to and movable relative to at least a portion of the pylon structure.

The aircraft of any preceding clause, wherein the engine is coupled to the pylon assembly at a forward engine mount and an aft engine mount.

The aircraft of any preceding clause, wherein the pylon control surface is coupled to the pylon structure rearward of the aft engine mount.

The aircraft of any preceding clause, wherein the pylon control surface is positioned between the forward and aft engine mounts.

The aircraft of any preceding clause, wherein the pylon structure further comprises an aft pylon casing at least partially encasing an aft mounting element of the pylon structure, the aft mounting element being coupled to the aft engine mount, the aft pylon casing being movable relative to the aft mounting element.

The aircraft of any preceding clause, wherein the aft pylon casing is configured to be moved relative to the aft mounting element with movement of the pylon control surface relative to aft engine mount.

The aircraft of any preceding clause, wherein the pylon control surface is configured as a rudder extending between the engine and the aircraft body.

The aircraft of any preceding clause, wherein the pylon assembly is configured to function as a vertical stabilizer.

The aircraft of any preceding clause, further comprising a tail assembly extending outwardly from the engine opposite the pylon assembly, the tail assembly comprising a tail structure coupled to the engine and a tail control surface movable relative to at least a portion of the tail structure.

The aircraft of any preceding clause, wherein each of the pylon control surface and the tail control surface comprises a vertically oriented control surface.

The aircraft of any preceding clause, wherein the pylon assembly and the tail assembly are oriented at a non-zero angle relative to a vertical direction.

The aircraft of any preceding clause, further comprising an elevator assembly extending outwardly from the engine, the elevator assembly comprising an elevator control surface.

The aircraft of any preceding clause, wherein the engine comprises a first engine, further comprising a second engine and a second pylon assembly extending between the aircraft body and the second engine, the second pylon assembly comprising a second pylon structure coupling the second engine to the aircraft body and a second a pylon control surface coupled to and movable relative to at least a portion of the second pylon structure.

The aircraft of any preceding clause, further comprising a first elevator assembly extending from the first engine and a second elevator assembly extending from the second engine, the first and second elevator assemblies extending outwardly from the first and second engines, each of the first and second elevator assemblies comprising an elevator control surface.

The aircraft of any preceding clause, further comprising an elevator assembly extending between the first and second engines, the elevator assembly comprising an elevator control surface.

The aircraft of any preceding clause, wherein the pylon control surface is coupled to and movable relative to the at least a portion of the pylon structure at a location between the engine and the aircraft body.

The aircraft of any preceding clause, wherein the aircraft body is a blended wing body.

A pylon assembly for an aircraft, the pylon assembly comprising: a pylon structure configured to extend between an aircraft body and an engine of the aircraft, the pylon structure comprising one or more internal pylon mounting elements configured to be coupled to the engine at forward and aft engine mounts; and a pylon control surface coupled to and movable relative to at least a portion of the pylon structure.

The pylon assembly of any preceding clause, wherein the pylon control surface is coupled to an aft portion of the pylon structure and extends rearwardly therefrom.

The pylon assembly of any preceding clause, wherein the pylon structure comprises a forward pylon casing and an aft pylon casing spaced apart from the forward pylon casing, the pylon control surface being positioned between the forward and aft pylon casings.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An aircraft, comprising:
an aircraft body;
an engine supported relative to the aircraft body; and
a pylon assembly extending between the aircraft body and the engine, the pylon assembly comprising:
a pylon structure coupling the engine to the aircraft body; and
a pylon control surface coupled to and movable relative to at least a portion of the pylon structure.

2. The aircraft of claim 1, wherein the engine is coupled to the pylon assembly at a forward engine mount and an aft engine mount.

3. The aircraft of claim 2, wherein the pylon control surface is coupled to the pylon structure rearward of the aft engine mount.

4. The aircraft of claim 2, wherein the pylon control surface is positioned between the forward and aft engine mounts.

5. The aircraft of claim 4, wherein the pylon structure further comprises an aft pylon casing at least partially encasing an aft mounting element of the pylon structure, the aft mounting element being coupled to the aft engine mount, the aft pylon casing being movable relative to the aft mounting element.

6. The aircraft of claim 5, wherein the aft pylon casing is configured to be moved relative to the aft mounting element with movement of the pylon control surface relative to aft engine mount.

7. The aircraft of claim 1, wherein the pylon control surface is configured as a rudder extending between the engine and the aircraft body.

8. The aircraft of claim 7, wherein the pylon assembly is configured to function as a vertical stabilizer.

9. The aircraft of claim 1, further comprising a tail assembly extending outwardly from the engine opposite the pylon assembly, the tail assembly comprising a tail structure coupled to the engine and a tail control surface movable relative to at least a portion of the tail structure.

10. The aircraft of claim 9, wherein each of the pylon control surface and the tail control surface comprises a vertically oriented control surface.

11. The aircraft of claim 9, wherein the pylon assembly and the tail assembly are oriented at a non-zero angle relative to a vertical direction.

12. The aircraft of claim 1, further comprising an elevator assembly extending outwardly from the engine, the elevator assembly comprising an elevator control surface.

13. The aircraft of claim 1, wherein the engine comprises a first engine, further comprising a second engine and a second pylon assembly extending between the aircraft body and the second engine, the second pylon assembly comprising a second pylon structure coupling the second engine to the aircraft body and a second a pylon control surface coupled to and movable relative to at least a portion of the second pylon structure.

14. The aircraft of claim 13, further comprising a first elevator assembly extending from the first engine and a second elevator assembly extending from the second engine, the first and second elevator assemblies extending outwardly from the first and second engines, each of the first and second elevator assemblies comprising an elevator control surface.

15. The aircraft of claim 13, further comprising an elevator assembly extending between the first and second engines, the elevator assembly comprising an elevator control surface.

16. The aircraft of claim 1, wherein the pylon control surface is coupled to and movable relative to the at least a portion of the pylon structure at a location between the engine and the aircraft body.

17. The aircraft of claim 1, wherein the aircraft body is a blended wing body.

18. A pylon assembly for an aircraft, the pylon assembly comprising:
a pylon structure configured to extend between an aircraft body and an engine of the aircraft, the pylon structure comprising one or more internal pylon mounting elements configured to be coupled to the engine at forward and aft engine mounts; and
a pylon control surface coupled to and movable relative to at least a portion of the pylon structure.

19. The pylon assembly of claim 18, wherein the pylon control surface is coupled to an aft portion of the pylon structure and extends rearwardly therefrom.

20. The pylon assembly of claim 18, wherein the pylon structure comprises a forward pylon casing and an aft pylon casing spaced apart from the forward pylon casing, the pylon control surface being positioned between the forward and aft pylon casings.
